(19) United States
(12) Patent Application Publication
(10) Pub. No.: US 2008/0188100 A1
(43) Pub. Date: Aug. 7, 2008

(54) Press-Fit Terminal, a Method for Manufacturing the Same, and a Structure of Connection Between a Press-Fit Terminal and a Circuit Board

(75) Inventor: Yasushi Saitoh, Mie (JP)

Correspondence Address: OLIFF & BERRIDGE, PLC, P.O. BOX 320850, ALEXANDRIA, VA, 22320-4850, US

(73) Assignees: AUTONEWORKS TECHNOLOGIES, LTD., YOKKAICHI-SHI (JP); SUMITOMO WIRING SYSTEMS, LTD., YOKKAICHI-SHI (JP); SUMITOMO ELECTRIC INSUSTRIES, LTD., OSAKA-SHI (JP)

(21) Appl. No.: 11/664,934

(22) PCT Filed: Jan. 17, 2006
(86) PCT No.: PCT/JP2006/300526

§ 371 Date: Apr. 9, 2007

(30) Foreign Application Priority Data
Jan. 18, 2005 (JP) 2005-010235

(51) Int. Cl. H01R 13/03; H01R 43/16

(52) U.S. Cl. 439/82; 29/885

(57) ABSTRACT

To provide a press-fit terminal with excellent connection reliability of which a plating surface is not scraped off when press-fitted into a through hole of a circuit board.

Manufacture of the press-fit terminal for inserting into the conductive through hole of the circuit board includes the steps of forming an underplating layer including one or more plating layers on a surface of a terminal base of a connecting part of the press-fit terminal which comes into electrical contact with the through hole, forming an Sn plating layer on the top plating layer, and after the step of forming the Sn plating layer, conducting a reflow process of performing heat treatment to form an alloy layer of Sn and an underplating metal of the top plating layer on the underplating layer as well as make unalloyed Sn mixed in an outside layer of the alloy layer.

### TECHNICAL FIELD

The present invention relates to a press-fit terminal to be inserted into and fit to a through hole of a printed circuit board and the like, specifically, a press-fit terminal of which an Sn plating layer on an outer surface of a connecting part is not scraped off when press-fitted into a through hole of a printed circuit board and the like, a method for manufacturing the press-fit terminal, and a structure of connection between the press-fit terminal and the circuit board.

### BACKGROUND ART

Conventionally, in electrical connection between a circuit board such as a printed circuit board and connector terminals, it is widely known that the connector terminals are press-fitted into conductive through holes of the circuit board to be mechanically fixed without soldering. The terminal used there is called a press-fit terminal, which has a terminal-inserting part which is inserted into the circuit board, a terminal-attaching part which is inserted into and fit to a connector for PCB and the like, and a press-fit connecting part which is placed between the terminal-inserting part and the terminal-attaching part and comes into electrical contact with the through hole.

This press-fit terminal is configured so that the terminal-inserting part is first inserted into the through hole of the circuit board, and the press-fit connecting part of which the width is larger than the through hole diameter is press-fitted into the through hole to generate contact load, and thereby electrical and mechanical connections are obtained.

In such a case, for obtaining low and stable contact resistance in the connections, Sn plating is generally provided to at least an outer surface of the press-fit connecting part which comes into contact with the through hole.

Japanese Patent Application Unexamined Publication No. Hei 11-135226 relates to a method for manufacturing an interfit-type connector in which Sn plating is provided to terminal surfaces for reducing an insertion force of terminals while stable contact resistance is maintained.

Specifically, Japanese Patent Application Unexamined Publication No. Hei 11-135226 discloses that an Ni plating layer is formed on the terminal surfaces, a Cu plating layer is formed thereon, and an Sn plating layer is formed thereon, and then heat treatment is performed on terminal bases at temperatures between 150 to 170° C. inclusive to leave the Sn plating layer at a thickness between 0.1 to 0.3 μm in a sliding part of one of the terminals and to leave the Sn plating layer at a thickness of 0.1 μm or more in a sliding part of the other terminal.

However, since Cu plating is generally provided to an inner surface of the through hole and the Sn plating layer is softer than the Cu plating layer, the terminal in which the Sn plating layer is lightly left on the terminal surface as mentioned above renders a problem that the Sn plating layer of the terminal is scraped off by an edge of the through hole to generate scraped-off pieces when the terminal is press-fitted into the through hole, so that shorts or malfunctions occur in the circuit.

To counter this problem, there are a method of sucking the generated scraped-off pieces, a method of using Ni harder than Sn as a metal used for plating of the terminal, and the like. However, the method of sucking has such problems that the positioning of the circuit board and the connector sometimes makes sucking difficult, an examination to verify complete removal is complicated, and the necessity of equipment for sucking leads to cost increase. In addition, in the method of using Ni as the terminal plating metal, Sn needs to be used as a metal for plating of the through hole in view of connection reliability, and there arises a problem of difficulty or high cost in acquisition of the circuit board.

### I. DISCLOSURE OF THE INVENTION

### Problem to be Solved by the Invention

An object of the invention is to overcome the problems described above and to provide a press-fit terminal with excellent connection reliability of which an Sn plating layer on an outer surface is not scraped off when press-fitted into a through hole of a circuit board, a method for manufacturing the same, and a structure of connection between the press-fit terminal and the circuit board.

### Means for Solving Problem

To achieve the objects and in accordance with the purpose of the present invention, as described in claim 1, a press-fit terminal consistent with the invention to be inserted into a conductive through hole of a circuit board is characterized as having an underplating layer including one or more plating layers, being formed on a surface of a terminal base in a connecting part of the press-fit terminal which comes into electrical contact with the through hole, an alloy layer of Sn and an underplating metal of the top plating layer, being formed on the underplating layer, and unalloyed Sn, being mixed in the alloy layer while having a depth of a few to 50 nm from an outside surface of the alloy layer.

As described in claim 2, the unalloyed Sn may be islanded in the alloy layer while having a depth of a few to 50 nm from the outside surface of the alloy layer.

As described in claim 3, it is preferable that when the underplating layer includes one plating layer, a plating metal of the plating layer is one of Ni and Cu.

As described in claim 4, it is also preferable that when the underplating layer includes two plating layers, plating metals of the plating layers are one of Ni and Cu, and Cu and Ni in order from the surface of the terminal base.

As described in claim 5, it is also preferable that when the underplating layer includes three plating layers, plating metals of the plating layers are Cu, Ni and Cu in order from the surface of the terminal base.

A method for manufacturing a press-fit terminal consistent with the present invention, as described in claim 6, includes the steps of forming an underplating layer including one or more plating layers on a surface of a terminal base in a connecting part of the press-fit terminal which comes into electrical contact with the through hole, forming an Sn plating layer at a thickness of 0.1 to 0.7 μm on the top plating layer, and after the step of forming the Sn plating layer, conducting a reflow process of performing heat treatment to form an alloy layer of Sn and an underplating metal of the top plating layer on the underplating layer as well as make unalloyed Sn mixed in the alloy layer so as to have a depth of a few to 50 nm from an outside surface of the alloy layer.

As described in claim 8, in the step of conducting the reflow process, the unalloyed Sn may be made islanded in the alloy layer so as to have a depth of a few to 50 nm from the outside surface of the alloy layer.

As described in claim 10, it is preferable that when the underplating layer includes one plating layer, a plating metal of the plating layer is one of Ni and Cu.

As described in claim 11, it is also preferable that when the underplating layer includes two plating layers, plating metals of the plating layers are one of Ni and Cu, and Cu and Ni in order from the surface of the terminal base.

As described in claim 12, it is also preferable that when the underplating layer includes three plating layers, plating metals of the plating layers are Cu, Ni and Cu in order from the surface of the terminal base.

As described in claim 13, it is preferable that a heat treatment temperature in the step of conducting the reflow process is from 200 to 270° C. inclusive.

In addition, as described in claim 14, a structure of connection between a press-fit terminal and a conductive through hole of a circuit board consistent with the present invention is characterized in that an underplating layer including one or more plating layers is formed on a surface of a terminal base in a connecting part of the press-fit terminal, an alloy layer of Sn and an underplating metal of the top plating layer is formed on the underplating layer, unalloyed Sn is mixed in the alloy layer while having a depth of a few to 50 nm from an outside surface of the alloy layer, and surface hardness of the press-fit connecting part is higher than surface hardness of a connecting part of the through hole.

As described in claim 15, the unalloyed Sn may be islanded in the alloy layer while having a depth of a few to 50 nm from the outside surface of the alloy layer.

As described in claim 16, it is preferable that when the underplating layer includes one plating layer, a plating metal of the plating layer is one of Ni and Cu.

As described in claim 17, it is also preferable that when the underplating layer includes two plating layers, plating metals of the plating layers are one of Ni and Cu, and Cu and Ni in order from the surface of the terminal base.

As described in claim 18, it is also preferable that when the underplating layer includes three plating layers, plating metals of the plating layers are Cu, Ni and Cu from the surface of the terminal base.

### EFFECT OF THE INVENTION

According to the press-fit terminal described in claim 1, the press-fit connecting part has a layer in which the unalloyed Sn having a depth of a few to 50 nm from an outer surface of the layer and the Sn based alloy are mixed. Hardness of the Sn based alloy layer is made considerably higher than that of Cu plating provided to an inner surface of the through hole of the circuit board. Therefore, the force exerted on the press-fit connecting part when the press-fit terminal is press-fitted is received by the hard part to protect the unalloyed Sn, so that the plating layer can be prevented from being scraped off.

In addition, the unalloyed Sn which is mixed in the alloy layer while having a depth of a few to 50 nm from the outside surface of the alloy layer has very soft properties, thereby increasing a contact area in the press-fit connecting part not to give interstices in a connection interface. Thus, oxygen can be prevented from entering, so that an increase in contact resistance due to degradation by oxidation and the like of the plating can be reduced even in hot environment.

The unalloyed Sn as above can achieve the same action and effect as the press-fit terminal described in claim 1 even when the unalloyed Sn is islanded in the alloy layer while having a depth of a few to 50 nm from the outside surface of the alloy layer.

In addition, when the plating metal of the top plating layer is Ni or Cu in claims 3 to 5, since, for example, hardness of the alloy of Sn and the underplating metal of the top plating layer which is formed on the underplating layer is higher than hardness of Cu plating provided to the through hole of the circuit board, the scraping-off of the plating layer on the terminal surface which occurs when the Sn-plated press-fit terminal is press-fitted into the through hole can be prevented.

The underplating metal is Ni in some cases because if the terminal base is made of a copper-zinc alloy, it prevents the Zn element in the terminal base from being diffused to the Sn layer by heat treatment.

In addition, the plating layer closest to the surface of the terminal base is the Cu layer in some cases because if a terminal base to which Ni plating is difficult to adhere is selected, the interposing of Cu improves wet properties and the like of Ni plating.

By making the underplating layer include one to three layers: the plating metal is one of Ni and Cu when the underplating layer includes one plating layer; the plating metals of the plating layers are one of Ni and Cu, and Cu and Ni in order from the surface of the terminal base when the underplating layer includes two plating layers; and the plating metals of the plating layers are Cu, Ni and Cu in order from the surface of the terminal base when the underplating layer includes three plating layers, the underplating layer is adaptable to terminal bases including a variety of base materials.

According to the method for manufacturing the press-fit terminal as described in claim 7, the alloy layer of Sn and the underplating metal of the top plating layer can be formed on the underplating layer, and the unalloyed Sn can be made mixed in the alloy layer so as to have a depth of a few to 50 nm from the outside surface of the alloy layer; accordingly, the scraping-off of the plating layer on the terminal surface in the press-fit connecting part can be prevented.

In addition, since the contact area in the press-fit connecting part is increased, contact resistance can be lowered. Additionally, since the degradation by oxidation and the like of the plating is reduced even in the use in hot environment, a press-fit terminal with excellent connection reliability can be manufactured.

Even when the unalloyed Sn is made islanded in the alloy layer so as to have a depth of a few to 50 nm from the outside surface of the alloy layer according to the method for manufacturing the press-fit terminal as described in claim 8, the same action and effect as the press-fit terminal as described in claim 7 can be achieved.

By the use of Ni or Cu as the underplating metal as described in claims 10 to 12, an alloy layer with higher hardness than the Cu plating provided to the through hole of the circuit board can be formed on the underplating layer.

In addition, by making the underplating layer include one to three plating layers: the plating metal is Ni or Cu when the underplating layer includes one plating layer; the plating metals of the plating layers are Ni and Cu or Cu and Ni in order from the surface of the terminal base when the underplating layer includes two plating layers; and the plating metals of the plating layers are Cu, Ni and Cu in order from the surface of the terminal base when the underplating layer includes three plating layers, the underplating layer is adaptable to terminal bases including a variety of base materials.

In addition, by making the heat treatment temperature in the step of conducting the reflow process be from 200 to 270° C. inclusive as described in claim 13, it becomes possible to form the alloy layer of Sn and the underplating metal of the top plating layer on the underplating layer and make the unalloyed Sn mixed or islanded in the alloy layer so as to have a depth of a few to 50 nm from the outside surface of the alloy layer.

By employing the structure of connection between the press-fit terminal and the circuit board as described in claim 14, shorts or malfunctions of the circuit due to the scraping-off of the plating layer on the terminal surface can be prevented. In addition, low and stable contact resistance can be maintained in hot environment, so that connection reliability becomes excellent.

Even when the unalloyed Sn is islanded in the alloy layer while having a depth of a few to 50 nm from the outside surface of the alloy layer formed on the surface of the terminal base in the press-fit connecting part as described in claim 15, the same action and effect as the structure of connection between the press-fit terminal and the circuit board as described in claim 14 can be achieved.

A variety of underplating can be made as described in claims 16 to 18.

### BRIEF DESCRIPTION OF THE DRAWINGS

FIG. 1 is a view showing a state where a press-fit terminal consistent with the preferred embodiment of the present invention is to be inserted into and fit to a conductive through hole of a circuit board;

FIG. 2 is an oblique view of an appearance of plating on a surface of the press-fit terminal consistent with the preferred embodiment of the present invention;

FIGS. 3A to 3E are views showing plating structures on the surface of the press-fit terminal consistent with the preferred embodiment of the present invention;

FIG. 4 shows an SEM observation image after conducting a reflow process on the surface of the press-fit terminal consistent with the preferred embodiment of the present invention;

FIGS. 5A and 5B are graphs showing results of AES (Auger Electron Spectroscopy) after conducting the reflow process on the surface of the press-fit terminal consistent with the preferred embodiment of the present invention;

FIG. 6 shows an SIM observation image of a connection interface between the press-fit terminal consistent with the preferred embodiment of the present invention and the conductive through hole of the circuit board;

FIG. 7 shows an SIM observation image of a connection interface between a press-fit terminal in which only Ni plating is provided to a press-fit connecting part and the conductive through hole of the circuit board;

FIG. 8 is a graph showing a change of contact resistance in hot environment in the case of connecting the press-fit terminal consistent with the preferred embodiment of the present invention and the conductive through hole of the circuit board;

FIG. 9 is a graph showing a change of contact resistance in hot environment in the case of connecting the press-fit terminal in which only Ni plating is provided to the press-fit connecting part and the conductive through hole of the circuit board;

FIG. 10 is a graph showing a temperature profile in the reflow process on the surface of the press-fit terminal consistent with the preferred embodiment of the present invention; and

FIGS. 11A to 11G are views showing cross-sectional shapes of press-fit connecting parts of a variety of press-fit terminals.

### BEST MODE FOR CARRYING OUT THE INVENTION

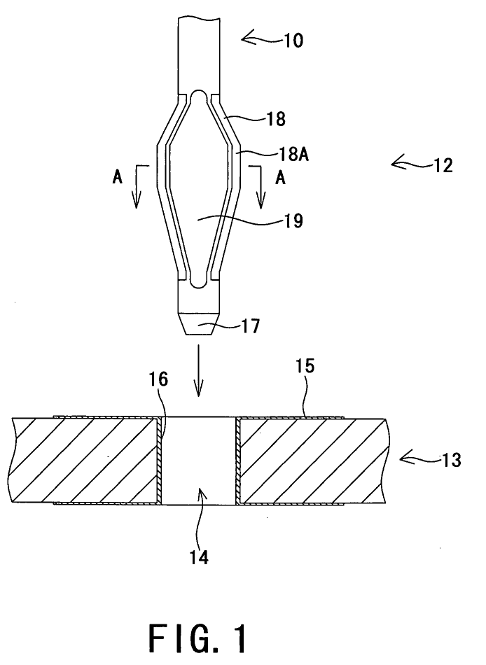

A detailed description of one preferred embodiment of the present invention will now be given with reference to FIGS. 1 to 11G.

A press-fit terminal 10 consistent with the preferred embodiment of the present invention as shown in FIG. 1 is formed by performing press working on a wire of a metal excellent in conductivity such as a copper base alloy. A board connecting part 12 is configured to be inserted into a through hole 14 of a circuit board 13 such as a printed circuit board.

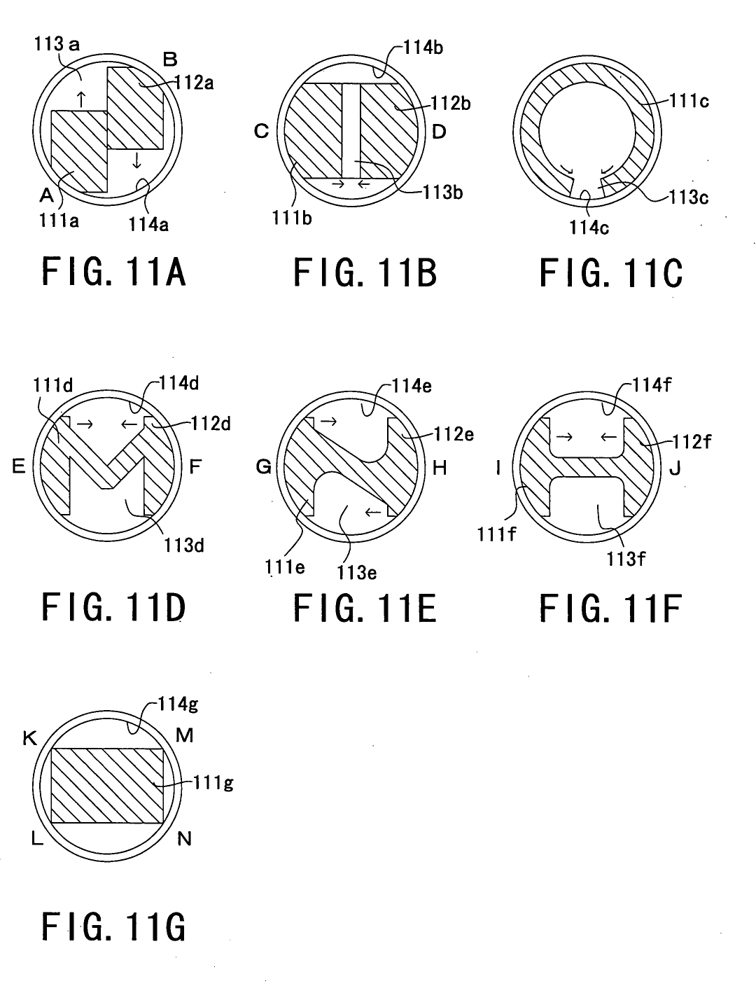

FIGS. 11A to 11G are views showing examples of cross-sectional shapes of connecting parts of a variety of press-fit terminals.

The press-fit terminals shown in FIGS. 11A and 11B are called a separate-beam type terminal. The one in FIG. 11A is particularly called a staggered type terminal. Two separate quadrates 111a and 112a are formed to be staggered in cross section, which are moved in their respective arrow directions shown in FIG. 11A inside a channel part 113a, so that the press-fit terminal is deformed to be insertable into the through hole and is press-fitted thereinto. Thus, the press-fit terminal is fixed in electrical contact with an inner surface 114a of the through hole via two points A and B.

The one in FIG. 11B is particularly called a needle type-I terminal, where two separate quadrates 111b and 112b are formed in cross section, and a channel part 113b is formed between the quadrates 111b and 112b. The quadrates 111b and 112b are moved in their respective arrow directions shown in FIG. 11B inside the channel part 113b, so that the press-fit terminal is press-fitted into the through hole and fixed in electrical contact with an inner surface 114b of the through hole via two planes C and D.

The press-fit terminals shown in FIGS. 11C to 11F respectively take the shape of a letter of the alphabet in cross section, and the alphabetical shape is deformed.

The one shown in FIG. 11C is particularly called a C-shape terminal, where the alphabetical shape of a letter C is formed in cross section. A terminal cross-section 111c is elastically deformed in the arrow direction inside a channel part 113c to reduce the diameter of the C-shape terminal so that the terminal is press-fitted into the through hole to be fixed in electrical contact with an inner surface 114c of the through hole via all over the outer surface of the press-fit connecting part.

The one shown in FIG. 11D is particularly called an M-shape terminal, where the alphabetical shape of a letter M is formed in cross section. Terminal cross-sections 111d and 112d are elastically deformed in their respective arrow directions shown in FIG. 11D inside a channel part 113d so that the M-shape terminal is press-fitted into the through hole to be fixed in electrical contact with an inner surface 114d of the through hole via two planes E and F.

The one shown in FIG. 11E is particularly called an N-shape terminal, where the alphabetical shape of a letter N is formed in cross section. Terminal cross-sections 111e and 112e are elastically deformed in their respective arrow directions shown in FIG. 11E inside a channel part 113e so that the N-shape terminal is press-fitted into the through hole to be fixed in electrical contact with an inner surface 114e of the through hole via two planes G and H.

The one shown in FIG. 11F is particularly called an H-shape terminal, where the alphabetical shape of a letter H is formed in cross section. Terminal cross-sections 111f and 112f are elastically deformed in their respective arrow directions shown in FIG. 11F inside a channel part 113f so that the H-shape terminal is press-fitted into the through hole to be fixed in electrical contact with an inner surface 114f of the through hole via two planes I and J.

The terminals having the cross-sectional shapes shown in FIGS. 11A to 11F are great in an amount of elastic deformation of the press-fit connecting part, and therefore are easy to respond to variations in size of the through hole diameter of the printed circuit board, thus currently being a predominant terminal.

The press-fit terminal shown in FIG. 11G is called a solid-type terminal, where a quadrate is formed in cross section, and the terminal is configured to be fixed in electrical contact with an inner surface 114g of the through hole via four points K, L, M and N. The solid-type terminal, which is small in an amount of elastic deformation of the press-fit connecting part, is press-fitted into the through hole through plastic deformation.

A variety of conductive paths 15 are formed on a surface of the circuit board 13, and a number of through holes 14 are formed in the circuit board 13. On an inner surface of the through hole 14, a contact part 16 is formed by plating and the like and connected with the conductive paths 15.

At the end of the board connecting part 12 of the press-fit terminal 10, a guide part 17 guiding the terminal to be inserted into the through hole 14 is formed, and above the guide part 17, a pair of elastic deformation parts 18 are formed over a length about two times larger than the depth of the through hole 14. The elastic deformation parts 18 are in a shape of a thick strip and expand outward to give an approximate-arc shape, and a channel part 19 is formed therein.

External surfaces of the press-fit terminal slightly above the center in the longitudinal direction form approximate linear parts 18A over a length of about one third of the total length, so as to be parallel to each other or form a gentle arc. A portion corresponding to the approximate linear parts 18A acts as the press-fit connecting part and comes into electrical contact with the contact part 16 of the through hole 14.

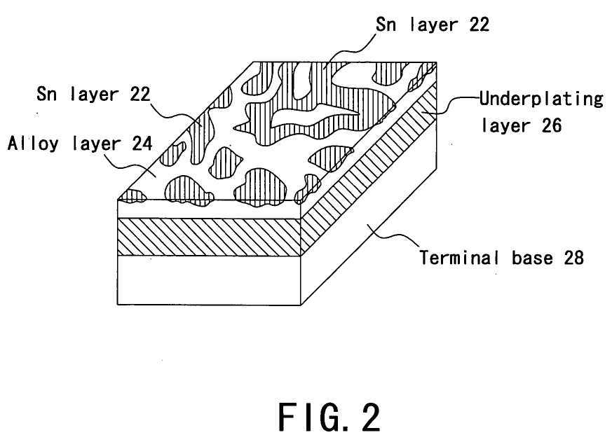

FIG. 2 is an oblique view of a structure of layers plated on the surface of the press-fit terminal consistent with the preferred embodiment of the present invention. In FIG. 2, an underplating layer 26 is formed on a terminal base 28, and an alloy layer 24 of an underplating metal and Sn is formed thereon, where an unalloyed Sn layer 22 is mixed. The unalloyed Sn layer 22 preferably has a depth of a few to 50 nm from an outside surface of the alloy layer 24.

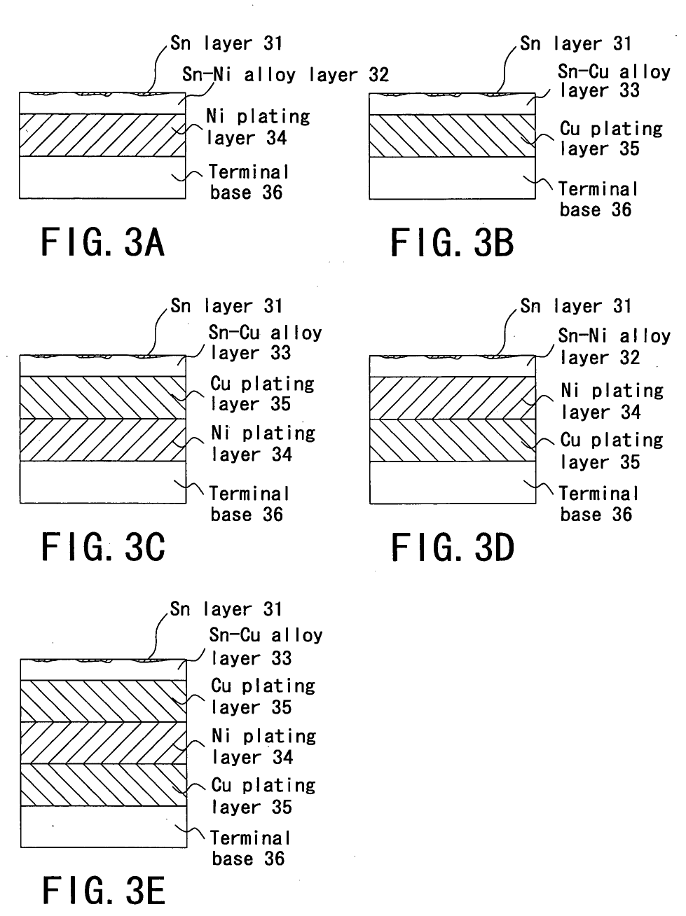

FIGS. 3A to 3E are views showing plating-layer structures in cross-section of the press-fit terminal consistent with the preferred embodiment of the present invention. FIG. 3A shows the structure where an Ni plating layer 34 is formed on a terminal base 36, an Sn—Ni alloy layer 32 is formed thereon, and an unalloyed Sn layer 31 is mixed in an outside layer of the Sn—Ni alloy layer 32. FIG. 3B shows the structure where a Cu plating layer 35 is formed on a terminal base 36, an Sn—Cu alloy layer 33 is formed thereon, and an unalloyed Sn layer 31 is mixed in an outside layer of the Sn—Cu alloy layer 33. The underplating layers in FIGS. 3A and 3B respectively include one plating layer.

FIG. 3C shows the structure where a Cu plating layer 35 and an Ni plating layer 34 from top as an underplating layer are formed on a terminal base 36, an Sn—Cu alloy layer 33 is formed thereon, and an unalloyed Sn layer 31 is mixed in an outside layer of the Sn—Cu alloy layer 33. FIG. 3D shows the structure where an Ni plating layer 34 and a Cu-plating layer 35 from top as an underplating layer are formed on a terminal base 36, an Sn—Ni alloy layer 32 is formed thereon, and an unalloyed Sn layer 31 is mixed in an outside layer of the Sn—Ni alloy layer 32. The underplating layers in FIGS. 3C and 3D respectively include two plating layers.

FIG. 3E shows the structure where a Cu plating layer 35, an Ni plating layer 34 and a Cu plating layer 35 from top as an underplating layer are formed on a terminal base 36, an Sn—Cu alloy layer 33 is formed thereon, and an unalloyed Sn layer 31 is mixed in an outside layer of the Sn—Cu alloy layer 33. The underplating layer in FIG. 3E includes three plating layers.

A process of providing plating to the press-fit terminal consistent with the present invention includes the steps of forming the underplating layer on the terminal base, forming the Sn plating layer on the top plating layer, and conducting a reflow process of performing heat treatment after the formation of the Sn plating layer.

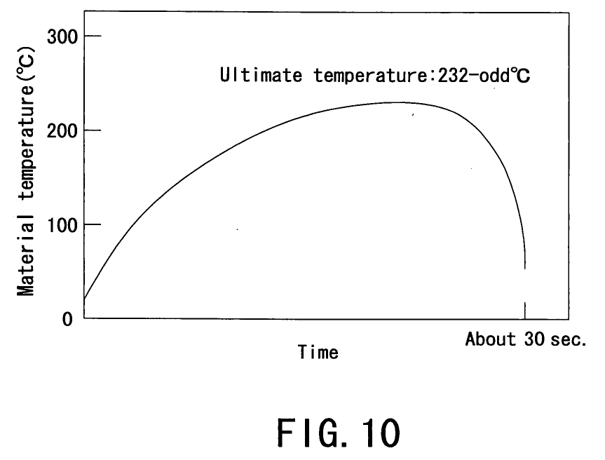

The method of forming the underplating layer or the Sn plating layer may be a generally-used plating method, and a description thereof is omitted. In the reflow process, a heat treatment temperature is preferably from 200 to 270° C. inclusive. It is essential only that the heat treatment temperature has a maximum ultimate temperature from 200 to 270° C., and it is preferable to raise the temperature from room temperature and reduce naturally or forcefully. A heat treatment time may be within a few seconds to a few minutes. FIG. 10 is a graph showing one example of a temperature profile of heat treatment.

With the above-mentioned reflow process, an alloy layer of Sn and an underplating metal of the top plating layer can be formed on the underplating layer, and unalloyed Sn can be made mixed in an outside layer of the alloy layer.

In the process of providing plating as mentioned above, the thickness of the Sn plating layer before heat treatment is preferably 0.1 to 0.7 μm. If less than 0.1 μm, it is hard to form a uniform Sn plating layer on the underplating layer, and if more than 0.7 μm, it is impossible to make unalloyed Sn mixed.

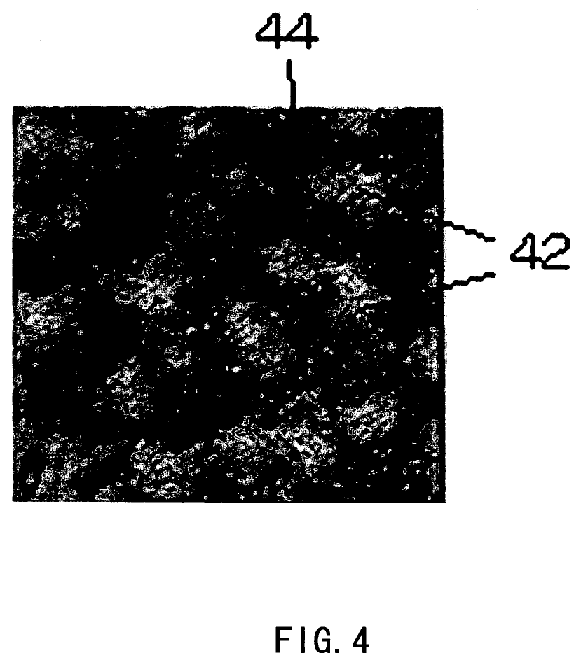

FIG. 4 is a view showing an observation image of a plating surface of the press-fit terminal consistent with the present invention after conducting the reflow process, which is observed by the use of an SEM.

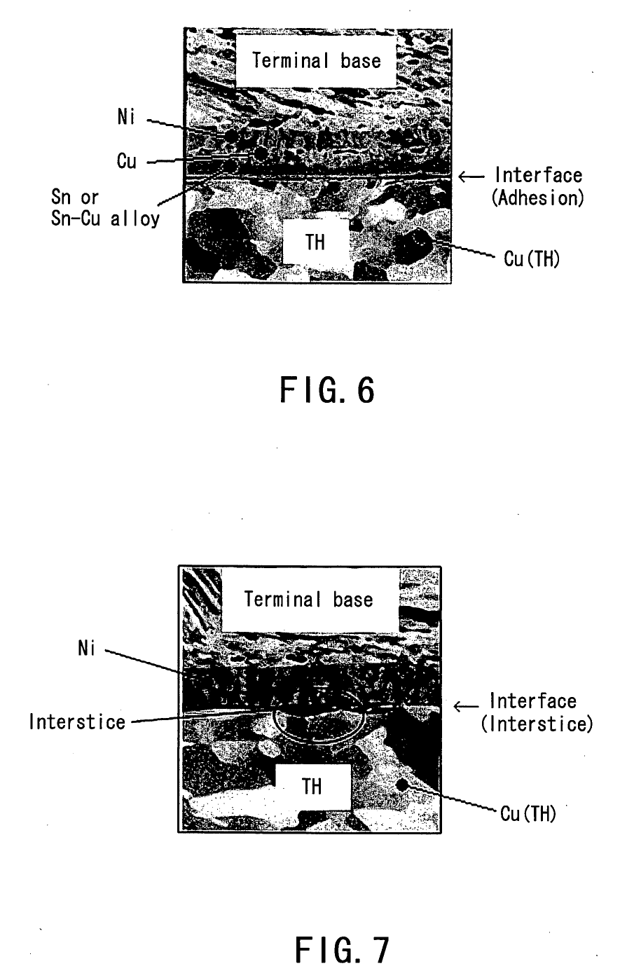

FIG. 6 is a view showing an image of a connection interface between the press-fit terminal consistent with the present invention (having the plating structure of FIG. 3C) and a through hole (TH), which is observed by an SIM (Scanning Ion Microscope). In FIG. 6, the through hole is positioned at the bottom, on which the unalloyed Sn and the alloy layer, the Cu plating layer, the Ni plating layer, and the terminal base are observed in this order from the connection interface.

FIG. 7 is a view showing an image of a connection interface between the press-fit terminal and the through hole when Ni plating is provided to the terminal base, which is observed by an SIM (Scanning Ion Microscope) In FIG. 7, the through hole is positioned at the bottom, on which the Ni plating layer and the terminal base are observed in this order from the connection interface.

Next, Examples of the present invention will be described in detail.

### EXAMPLE 1

Ni plating as an underplating layer was provided to a connecting part of a press-fit terminal having a copper based alloy as a base material, and Sn plating at a thickness of 0.4 μm was provided thereto. Then, heating-cooling treatment (of about 30 seconds) was made so that an ultimate maximum temperature became 232-odd ° C. under the temperature conditions shown in FIG. 10, and an Sn—Ni alloy layer was formed on the Ni plating layer.

Then, a plating surface of the press-fit terminal after the heating-cooling treatment (the reflow process) was observed by an SEM. An SEM image thereof is shown in FIG. 4.

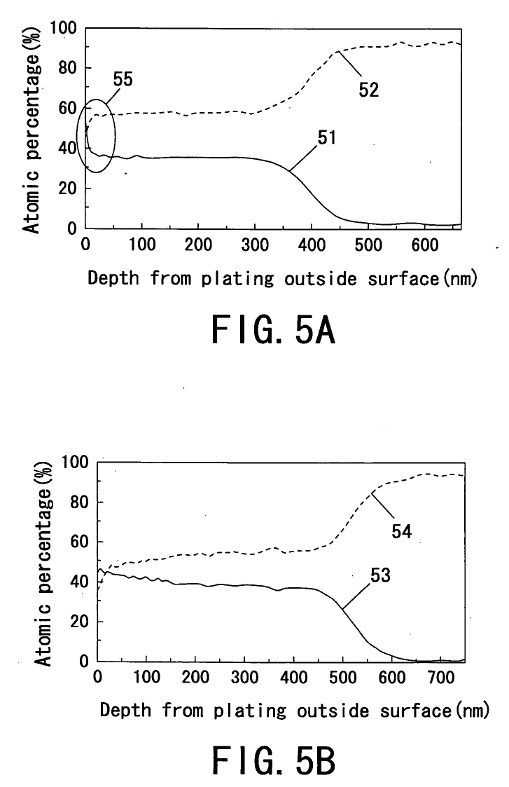

It was observed from the SEM image in FIG. 4 that white portions 42 and a black portion 44 are mixed. The percentages of Sn and Ni in the while portions 42 and the black portion 44 were measured by AES (Auger Electron Spectroscopy). Results thereof are shown in FIGS. 5A and 5B.

FIG. 5A shows measurement results on the white portions 42 shown in FIG. 4, and FIG. 5B shows measurement results on the black portion 44 shown in FIG. 4. In FIGS. 5A and 5B, the horizontal axis indicates a depth from a plating outside surface obtained at a measurement point, and the vertical axis indicates an atomic percentage (%) of an Sn element and an Ni element obtained at the measurement point.

Lines 51 and 53 indicate values of the Sn percentage, and lines 52 and 54 indicate values of the Ni percentage. In an ellipse 55, a change in the Sn percentage at a depth of a few to 50 nm in the white portions 42 is shown.

The lines 51 and 52 in FIG. 5A show that the Sn percentage is about 40% and the Ni percentage is about 60% constantly at a depth of 50 to 300 nm, from which it can be seen that an alloy layer of Sn and an underplating metal Ni was uniformly formed in this range of the white portions 42 in FIG. 4. As compared to the above range, at a depth of a few to 50 nm from the plating outside surface (in the ellipse 55), the Sn percentage was higher (50% to 60% at the maximum), and the Ni percentage was lower. It should be noted that a comparison between the diameter of a measurement beam in AES (Auger Electron Spectroscopy) and the diameter of the white portions 42 in FIG. 4 shows that the diameter of the measurement beam is greater, and a complete measurement of only the white portions 42 cannot be performed; accordingly, it is considered that an actual Sn percentage at a depth of a few to 50 nm from the plating outside surface is higher.

The lines 53 and 54 in FIG. 5B show that the Sn percentage is approximately constant at a depth of a few to 450 nm, from which it can be seen that the alloy layer of Sn and Ni was uniformly formed at a depth of a few to 450 nm. There was no part where the Sn percentage was partially high in the black portion 44.

Table 1 shows measurement results of surface hardness of the white portions 42 (soft part) and the black portion 44 (hard part) in FIG. 4. Table 1 also shows measurement results of surface hardness of the soft part and the hard part which were made mixed in the surface of the terminal base after conducting the reflow process, where the top plating layer is made of Cu. Table 2 shows data on surface hardness and the like in the case of using conventional Sn plating.

TABLE 1

| | Vickers hardness (Conversion HV) | | |
|---|---|---|---|
| Plating metal | Soft part | Hard part | Whole |
| Ni | 92 | 1104 | 735 |
| Cu | 92 | 828 | 552 |

TABLE 2

| Type of plating | Vickers hardness (Conversion HV) |
|---|---|
| Ni plating | 510 |
| Conventional Sn plating | 25 |
| Cu plating of through hole | 104 |

As shown in Table 1, the Vickers hardness of the white portions 42 (soft part) when the top plating layer is made of Ni was 92 HV, which was considerably lower than 1104 HV, the Vickers hardness of the black portion 44 (hard part), from which it can be seen that the white portions 42 and the black portion 44 are significantly different in composition. On the other hand, the Vickers hardness of the white portions 42 is considerably close to 25 HV, the Vickers hardness of the conventional Sn plating in Table 2. It is thus considered that the composition of the white portions 42 is similar to pure Sn and the white portions 42 are hardly alloyed. In contrast, the Vickers hardness of the black portion 44 is considerably higher than the Sn plating and is higher than the Ni plating, from which it can be seen that an alloy of Sn and an underplating metal (Ni) by diffusion is formed.

As a consequence, it is shown that the alloy layer of Sn and the underplating metal of the top plating layer is formed on the plating surface of the press-fit terminal consistent with the present invention, and the unalloyed Sn is mixed while having a depth of a few to 50 nm from the outside surface of the alloy layer.

A comparison between 735 HV shown in Table 1, the surface hardness of the press-fit connecting part (the surface hardness as a whole) when the top plating layer is made of Ni, and 104 HV shown in Table 2, the surface hardness of a connecting part of the Cu plated through hole, shows that the surface hardness of the press-fit connecting part is higher. Accordingly, it is possible to prevent the plating layer on the terminal base surface in the press-fit connecting part from being scraped off when the press-fit terminal is inserted into the Cu-plated through hole of the circuit board.

In addition, as shown in Table 1, when the top plating layer is made of Cu where the soft part and the hard part are mixed in the terminal base surface subjected to the reflow process after plating, the Vickers hardness of the soft part was 92 HV, and that of the hard part was 828 HV. As in the case of Ni, the soft part and the hard part on the terminal base surface are significantly different in composition, and the hardness of the soft part is considerably close to 25 HV, the hardness of the conventional Sn plating shown in Table 2; therefore, it is considered that the composition of the soft part is close to pure Sn, and the soft part is hardly alloyed.

As in the case of Ni, a comparison between 552 HV shown in Table 1, the surface hardness of the press-fit connecting part (the surface hardness as a whole) when the top plating layer is made of Cu, and 104 HV shown in Table 2, the surface hardness of the connecting part of the Cu-plated through hole, shows that the surface hardness of the press-fit connecting part is higher. Accordingly, it is possible to prevent the plating layer on the terminal base in the press-fit connecting part from being scraped off when the press-fit terminal is inserted into the Cu-plated through hole of the circuit board.

### EXAMPLES 2 AND 3

Similar to Example 1, underplating of an Ni metal was provided to connecting parts of press-fit terminals having a copper based alloy as a base material, and Sn plating at a thickness of 0.2 μm and Sn plating at a thickness of 0.7 μm were provided thereto, respectively. Then, heating-cooling treatment (of about 30 seconds) was made so that an ultimate maximum temperature became 232-odd ° C., and Sn—Ni alloy layers were formed on the Ni plating layers. Plating surfaces of the terminals were observed by an SEM, and it was observed, similar to Example 1, that unalloyed Sn was mixed in the outside layers of the Sn—Ni alloy layers.

### COMPARATIVE EXAMPLE 1

Similar to Example 1, underplating of an Ni metal was provided to a connecting part of a press-fit terminal having a copper-zinc based alloy as a base material, and Sn plating at a thickness of 0.8 μm was provided thereto. Then, heating-cooling treatment (of about 30 seconds) was made so that an ultimate maximum temperature became 232-odd ° C., and an Sn—Ni alloy layer was formed on the Ni plating layer. A plating surface of the terminal was observed by an SEM, and it was observed that unalloyed Sn was not mixed in the outside layer of the Sn—Ni alloy layer.

The press-fit terminals which were subjected to plating by the methods of Examples 1-3 and Comparative Example 1 were respectively press-fitted into the Cu-plated through hole of the circuit board, of which results are shown in Table 3.

TABLE 3

| | Plating thickness | | Scraping-off of |
|---|---|---|---|
| | (μm) | Island | plating |
| Example 1 | 0.4 | Observed | Not observed |
| Example 2 | 0.2 | Observed | Not observed |
| Example 3 | 0.7 | Observed | Not observed |
| Comparative | 0.8 | Not observed | Observed |
| Example 1 | | | |

In Examples 1-3, it was observed in the plating surface of the press-fit terminal after the heating-cooling treatment (the reflow process) that unalloyed Sn was mixed in the outside layer of the Sn—Ni alloy layer as shown in FIG. 4. When the press-fit terminals of Examples 1-3 were press-fitted into the Cu-plated through holes of the circuit board, the plating layers were not scraped off. In contrast, in the press-fit terminal of Comparative Example 1 (the conventional Sn-plating method) where the Sn plating was provided at a thickness of 0.8 μm, it was observed that unalloyed Sn was not mixed in the outside layer of the Sn—Ni alloy layer and the plating layer was scraped off.

It is considered that the scraping-off of the plating layer did not occur in Examples 1-3 because the alloy layer of Sn and the underplating metal (Ni) of the top plating layer was formed on the underplating layer (Ni plating layer), and unalloyed Sn was made mixed in the outside layer of the alloy layer, so that the alloy layer of extremely high surface hardness (1104 HV) protected the soft part (a part of unalloyed Sn of which surface hardness was 92 HV) by the force generated when the press-fit terminal was press-fitted into the Cu-plated through hole, and the surface hardness of the press-fit terminal as a whole (735 HV) exceeded the surface hardness of the Cu-plated through hole (104 HV).

In contrast, in Comparative Example 1, similar to the conventional Sn plating method, it was observed that unalloyed Sn was not mixed in the Sn—Ni alloy layer, and the scraping-off occurred because the surface hardness was the same as the conventional Sn plating (25 HV).

Next, in order to evaluate connection reliability between the press-fit terminal consistent with the present invention and the through hole of the circuit board, a connection interface when they were connected was observed, and connection properties (change in a value of contact resistance) in hot environment were tested.

### EXAMPLE 4

Ni plating and Cu plating as an underplating layer were provided in this order to a connecting part of a press-fit terminal having a copper based alloy as a base material, and Sn plating at a thickness of 0.4 μm was provided thereto. Then, heating-cooling treatment (of about 30 seconds) was made so that an ultimate maximum temperature became 232-odd ° C., and an Sn—Cu alloy layer was formed on the Cu plating layer. The press-fit terminal was press-fitted into and connected to the Cu-plated through hole of the circuit board, and their connection interface was observed by an SIM (Scanning Ion Microscope). In order to test the connection properties in hot environment, the press-fit terminal and the circuit board under connection were let stand for 1000 hours under temperature conditions of 125° C., and a time course change of contact resistance was measured.

### COMPARATIVE EXAMPLE 2

A press-fit terminal in which only Ni plating was provided to a connecting part thereof having a copper based alloy as a base material was press-fitted into and connected to the Cu-plated through hole of the circuit board, and their connection interface was observed by an SIM. In addition, in order to test the connection properties in hot environment, the press-fit terminal and the circuit board under connection were let stand for 500 hours under temperature conditions of 105° C., and a time course change of contact resistance was measured.

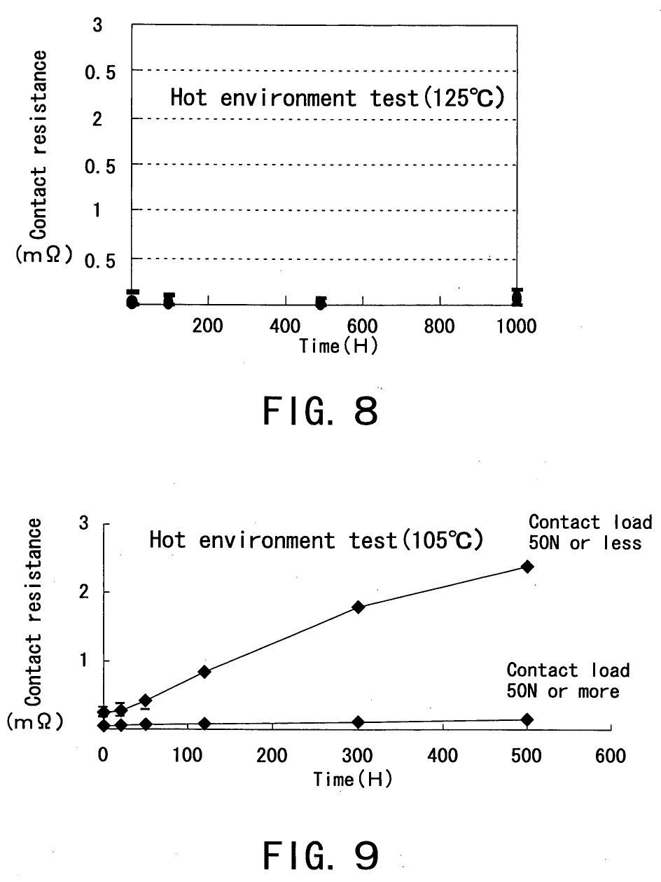

FIGS. 6 and 7 show SIM images of the connection interfaces of Example 4 and Comparative Example 2, respectively, and FIGS. 8 and 9 show results on the connection properties in hot environment of Example 4 and Comparative Example 2, respectively.

The connection interface between the press-fit terminal consistent with the present invention and the through hole (Example 4) was in favorable adhesion as shown in FIG. 6, and air tightness was maintained with no interstice. As a result, degradation by oxidation of the plating of the connection interface did not occur even in hot environment; therefore, contact resistance was not increased with time as shown in FIG. 8, and stable and favorable connection properties were shown.

In contrast, in the connection interface between the press-fit terminal with the Ni plating only and the through hole (Comparative Example 2), interstices were observed in the connection interface as shown in FIG. 7, and air tightness was not obtained. The change of contact resistance in hot environment was followed up in such a state, by which it was shown that contact resistance tended to increase with time as shown in FIG. 9, and this change was outstanding especially when the contact load was less than 50N, so that connection reliability was low.

In summary, the press-fit terminal consistent with the present invention solves such problems of the press-fit terminal which is Sn-plated with the conventional method that shorts, malfunctions or the like occur in the circuit because the Sn plating layer of the press-fit terminal is scraped off by the edge of the through hole to generate scraped-off pieces when the terminal is press-fitted into the through hole.

In addition, in the case of changing the plating metal to Ni for preventing the scraping-off of the plating layer, there is a problem of lowering connection reliability; however, this problem is also solved by the press-fit terminal consistent with the present invention as mentioned above.

The foregoing description of the preferred embodiments of the invention is not intended to be exhaustive or to limit the invention to the precise form disclosed, and modifications and variations are possible in the light of the above teachings or may be acquired from practice of the invention.

For example, in the above-mentioned Examples, a press-fit terminal with an underplating layer including one plating layer of which a plating metal is Cu, a press-fit terminal with an underplating layer including two plating layers of which plating metals are Cu and Ni in order from a surface of a terminal base, and a press-fit terminal with an underplating layer including three plating layers of which plating metals are Cu, Ni and Cu in order from a surface of a terminal base are not specifically presented; however, it goes without saying that the present invention can be applied to them because what is important is that an Sn plating layer is made to have a thickness from 0.1 to 0.7 μm, an alloy layer of an underplating metal of the top plating layer and Sn is formed by a reflow process, and unalloyed Sn is made mixed in an outside layer of the alloy layer.

### INDUSTRIAL APPLICABILITY

The press-fit terminal consistent with the present invention may be used in connection between wire boards in electrical wiring of an automobile and the like, and may be also used as a connecting terminal which ensures excellent connection reliability even under severe conditions such as high temperatures and strong vibrations at the time of automobile applications.

1. A press-fit terminal to be inserted into a conductive through hole of a circuit board, the press-fit terminal comprising:
an underplating layer including one or more plating layers, being formed on a surface of a terminal base in a connecting part of the press-fit terminal which comes into electrical contact with the through hole;
an alloy layer of Sn and an underplating metal of the top plating layer, being formed on the underplating layer; and
unalloyed Sn, being mixed in the alloy layer while having a depth of a few to 50 nm from an outside surface of the alloy layer.

2. The press-fit terminal according to claim 1, wherein the unalloyed Sn is islanded in the alloy layer while having a depth of a few to 50 nm from an outside surface of the alloy layer.

3. The press-fit terminal according to claim 1, wherein when the underplating layer includes one plating layer, a plating metal of the plating layer is one of Ni and Cu.

4. The press-fit terminal according to claim 1, wherein when the underplating layer includes two plating layers, plating metals of the plating layers are one of Ni and Cu, and Cu and Ni in order from the surface of the terminal base.

5. The press-fit terminal according to claim 1, wherein when the underplating layer includes three plating layers, plating metals of the plating layers are Cu, Ni and Cu in order from the surface of the terminal base.

6. (canceled)

7. A method for manufacturing a press-fit terminal for inserting into a conductive through hole of a circuit board, the method comprising the steps of:
forming an underplating layer including one or more plating layers on a surface of a terminal base in a connecting part of the press-fit terminal which comes into electrical contact with the through hole;
forming an Sn plating layer at a thickness of 0.1 to 0.7 μm on the top plating layer; and
after the step of forming the Sn plating layer, conducting a reflow process of performing heat treatment to form an alloy layer of Sn and an underplating metal of the top plating layer on the underplating layer as well as make unalloyed Sn mixed in the alloy layer so as to have a depth of a few to 50 nm from an outside surface of the alloy layer.

8. The method for manufacturing the press-fit terminal according to claim 7, wherein in the step of conducting the reflow process, the unalloyed Sn is made islanded in the alloy layer so as to have a depth of a few to 50 nm from the outside surface of the alloy layer.

9. (canceled)

10. The method for manufacturing the press-fit terminal according to claim 7, wherein when the underplating layer includes one plating layer, a plating metal of the plating layer is one of Ni and Cu.

11. The method for manufacturing the press-fit terminal according to claim 7 wherein when the underplating layer includes two plating layers, plating metals of the plating layers are one of Ni and Cu, and Cu and Ni in order from the surface of the terminal base.

12. The method for manufacturing the press-fit terminal according to claim 7, wherein when the underplating layer includes three plating layers, plating metals of the plating layers are Cu, Ni and Cu in order from the surface of the terminal base.

13. The method for manufacturing the press-fit terminal according to claim 7, wherein a heat treatment temperature in the step of conducting the reflow process is from 200 to 270° C. inclusive.

14. A structure of connection between a press-fit terminal and a conductive through hole of a circuit board, wherein
an underplating layer including one or more plating layers is formed on a surface of a terminal base in a connecting part of the press-fit terminal,
an alloy layer of Sn and an underplating metal of the top plating layer is formed on the underplating layer,
unalloyed Sn is mixed in the alloy layer while having a depth of a few to 50 nm from an outside surface of the alloy layer, and
surface hardness of the press-fit connecting part is higher than surface hardness of a connecting part of the through hole.

15. The structure of connection between the press-fit terminal and the circuit board according to claim 14, wherein the unalloyed Sn is islanded in the alloy layer while having a depth of a few to 50 nm from the outside surface of the alloy layer.

16. The structure of connection between the press-fit terminal and the circuit board according to claim 14, wherein when the underplating layer includes one plating layer, a plating metal of the plating layer is one of Ni and Cu.

17. The structure of connection between the press-fit terminal and the circuit board according to claim 14, wherein when the underplating layer includes two plating layers, plating metals of the plating layers are one of Ni and Cu, and Cu and Ni in order from the surface of the terminal base.

18. The structure of connection between the press-fit terminal and the circuit board according to claim 14, wherein when the underplating layer includes three plating layers, plating metals of the plating layers are Cu, Ni and Cu from the surface of the terminal base.

19. (canceled)
